(19) United States
(12) Patent Application Publication
(10) Pub. No.: US 2008/0141572 A1
(43) Pub. Date: Jun. 19, 2008

(54) FRONT AND BACK SERVICEABLE MODULAR INTERLOCKING GRAPHICS DISPLAY PANEL

(75) Inventors: Jeffrey C. Tomich, Pinellas Park, FL (US); Shawn Kottwitz, Largo, FL (US)

Correspondence Address: LARSON AND LARSON, 11199 69TH STREET NORTH, LARGO, FL, 33773, US

(73) Assignee: HI*TECH ELECTRONIC DISPLAYS, INC., Clearwater, FL (US)

(21) Appl. No.: 11/554,124

(22) Filed: Oct. 30, 2006

(51) Int. Cl. G09F 7/00

(52) U.S. Cl. 40/605

(57) ABSTRACT

A modular graphics display panel includes an enclosure with a front side and a back side. The front side has a front opening and the back side has a back opening. An array of display elements is mounted on one or more display tiles. The display tiles are removably affixed to the front opening of the enclosure such that components of the modular graphics display panel are serviceable from the front side of the enclosure when the back side is obstructed. An access door is removably affixed to the back opening of the enclosure such that components of the modular graphics display panel are serviceable from the rear side of the enclosure when the front side is inaccessible.

This application is related to U.S. application titled, “MODULAR INTERLOCKING GRAPHICS DISPLAY PANEL,” which was filed on even date herewith; attorney docket number 2236.0 and inventor Shawn Kottwitz.

### BACKGROUND OF THE INVENTION

1. Field of the Invention

This invention relates to the field of electronic display signs and more particularly to interlocking graphics display panels that can be service accessed from the front and from the back.

2. Description of the Related Art

There are many products and related patents in the field of electronic signs. To date, most electronic signs are monolithic, in that if a 10 foot by 8 foot sign is needed, a 10 foot by 8 foot sign is designed and built. This creates many issues. For one, a 10 foot by 8 foot sign is difficult to lift and move to the place where it will be used. Second, if someone else needs an 8 foot by 6 foot sign, a new sign needs to be custom built. Third, if needs change such as a larger sign is needed, the existing sign becomes useless and a totally new sign must be deployed. These issues are in addition to all of the issues common to graphic signs including protecting the sign from water, supporting the sign and connecting the sign to power and data. Furthermore, due to access conditions, it is often difficult to service these signs once installed due to the availability of access to the front and back. In some situations, only the back can be accessed. In other situations, it is impossible to get behind the sign and service must be performed from the front.

US Pat. Pub. No. 2005/0178034 to Schubert, et al, describes modular interlocking graphics panels that can be combined to form larger signs, thereby addressing some of the issues described above. These panels interlock with each other by a series of interlocking trapezoidal portions on its edges. Although addressing some of the problems cited, these panels have irregular edges and require a frame to support the panels and provide power, even if only one panel is deployed. There are no provisions in these panels to help reduce water buildup and damage.

Other modular signs exist that screw together and are supported by a frame. These signs cannot be easily disassembled, serviced, moved and reassembled.

What is needed is a system that provides modular interlocking display panels that can be service accessed from both the front and the back.

### SUMMARY OF THE INVENTION

An objective of the present invention is to provide a modular graphics display panel that is intended to be used independently or in conjunction with other modular graphics display panels as a display or sign. The modular graphics display panels of the present invention are serviceable from the front if the sign is obstructed at the back and from the back if the front of the sign isn't accessible.

In one embodiment, a modular graphics display panel is disclosed including an enclosure with a front side and a back side. The front side has a front opening and the back side has a back opening. An array of display elements is mounted on one or more display tiles. The display tiles are removably affixed to the front opening of the enclosure such that components of the modular graphics display panel are serviceable from the front side of the enclosure when the back side is obstructed. An access door is removably affixed to the back opening of the enclosure such that components of the modular graphics display panel are serviceable from the rear side of the enclosure when the front side is inaccessible.

In another embodiment, a method of servicing a modular display panels is disclosed including providing a modular display panel with an enclosure that has at least a front side and a back side, the front side has a front opening and the back side has a back opening. The modular display panel includes an array of display elements mounted on one or more display tiles and the display tiles are removably affixed to the front opening of the enclosure such that components of the modular graphics display panel are serviceable from the front side of the enclosure. The modular display panel also includes an access door that is removably affixed to the back opening of the enclosure such that components of the modular graphics display panel are serviceable from the rear side of the enclosure. The method continues with if the back side of the modular display panel is obstructed, servicing of the modular display panel is performed by removing at least one of the one or more display tiles and if the front side of the modular display panel is inaccessible, servicing of the modular display panel is performed by removing the access door.

In another embodiment, a modular graphics display sign is disclosed including at least a first modular graphics display panel and a second modular graphics display panel, each modular graphics display panel has an enclosure and a graphics display mounted on a front surface of a bezel affixed to a front opening in the enclosure. There are hardware devices to align the first modular graphics display panel with the second modular graphics display panel and electrical devices to transfer power and data from the first modular graphics display panel to the second modular graphics display panel. Additionally, there is a hardware device to physically hold the first modular graphics display panel to the second modular display panel.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a front perspective view of a modular graphic display panel of the present invention.

FIG. 1A illustrates a front perspective view of a modular graphic display panel of the present invention without power and data connectors.

FIG. 2 illustrates a front perspective view of a modular graphic display panel of the present invention turned upside down.

FIG. 3 illustrates a back view of a modular graphic display panel of the present invention.

FIG. 4 illustrates a single-lobe locking key of the present invention.

FIG. 5 illustrates a dual-lobe locking key of the present invention.

FIG. 6 illustrates a quad-lobe locking key of the present invention.

FIG. 7 illustrates a schematic back view of a modular graphic display panel of the present invention.

FIG. 8 illustrates a schematic back view of two assembled modular graphic display panels of the present invention.

FIG. 9 illustrates a schematic back view of four assembled modular graphic display panels of the present invention.

FIG. 10 illustrates a schematic view of two panels ready to be joined together.

FIG. 11 illustrates a schematic view of two panels after being joined together.

FIG. 12 illustrates a schematic view of four panels after being joined together.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

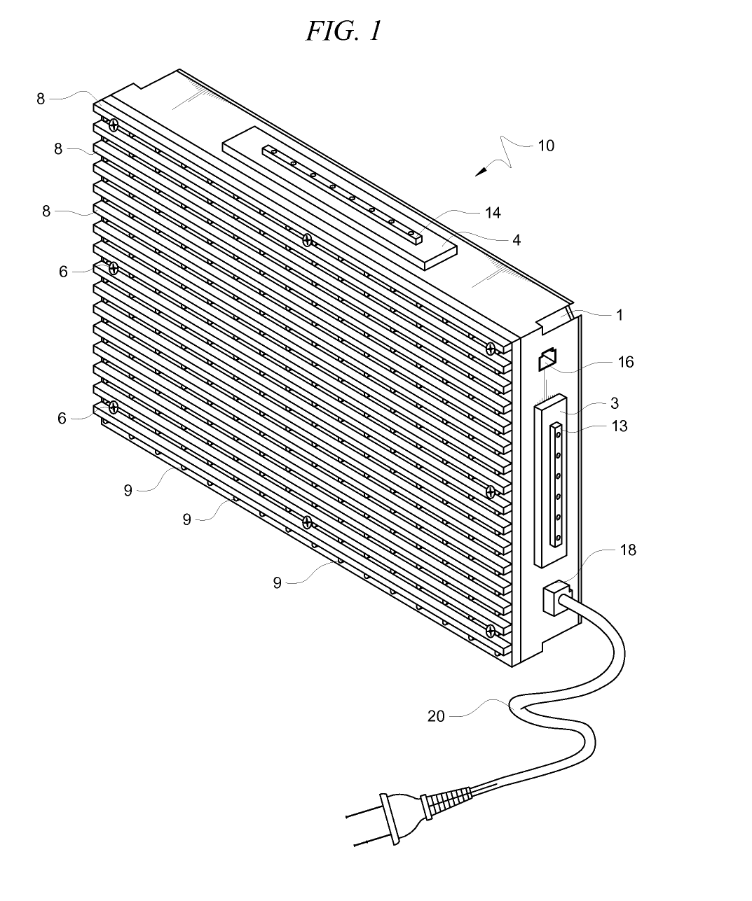

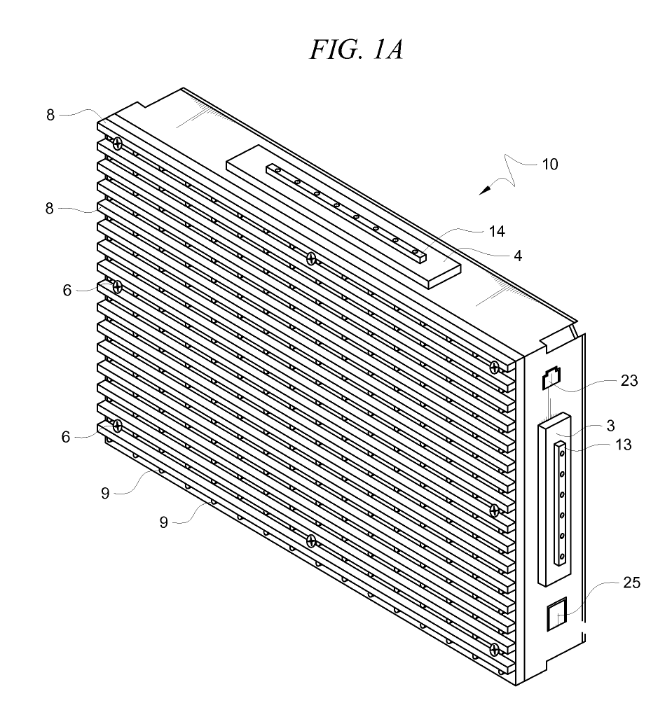

The modular graphic display panel 10 as shown in FIG. 1, FIG. 1A, 2 and 3 has an exemplary power input 20 going through a side of its enclosure through a strain-relief 18 and into the modular graphic display panel 10 for powering the electronics of this display panel and any other display panel connected to it. A data input connector 16 is located on the same side of the display panel 10 for connecting to a driving computer system. In this example, an RJ-45 connector 16 is provided but the present invention is not limited to any particular connector, input style or interface. The connector can be any type of connector including RJ-11, RJ-45, D, Sub-D, etc, or the input signal can be directly wired passing through a hole in the side of the graphics panel 10. The interface is any known in the industry including serial or parallel, USB, RS-232, fiber optic, proprietary, etc.

In the preferred embodiment, when multiple modular graphic display panels 10 are deployed, power and data are connected to the bottom, right display panel only as shown in FIG. 1. Thereafter, subsequent modular graphic display panels 10 as shown in FIG. 1A receive data and power through the side connectors 12/13/14/15. In terminal panels, the data connection hole and power connection hole are sealed with, for example, knock outs 23/25.

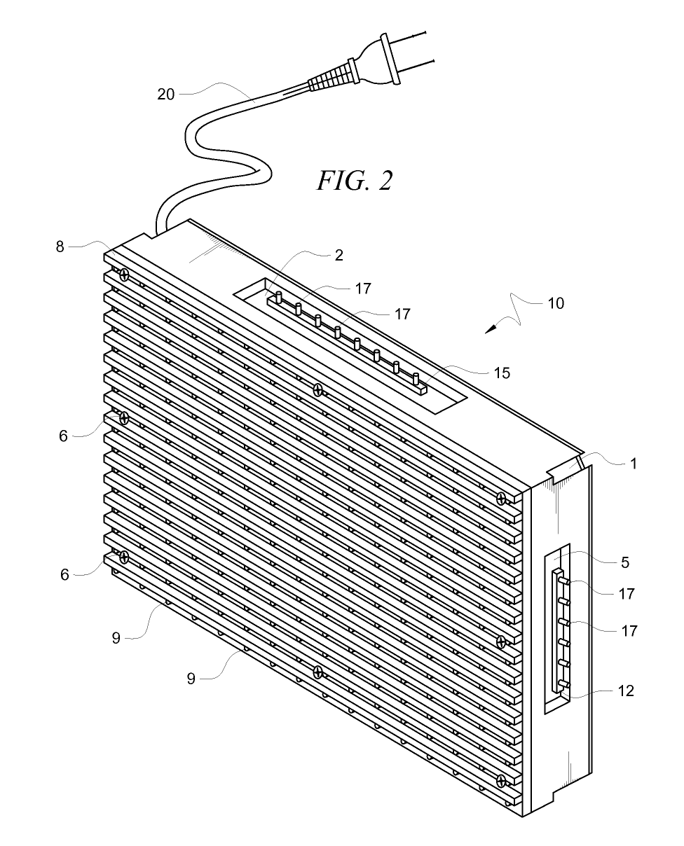

FIG. 1 and FIG. 1A show the front, top and right side of the modular graphic display panel 10 while FIG. 2 shows the front, bottom and left sides. When more than one modular graphic display panel 10 is integrated into a sign, power and data from the male pins 17 of the left connector 12 of a bottom right display panel 10 connects with female pins of the right connector 13 of a bottom left display panel 10. Likewise, power and data from the male pins 17 of the bottom connector 15 of a top right display panel 10 connects with female pins of the top connector 14 of a bottom right display panel 10, and so forth. Although the male connector can be located within a dimple 2/5 or on a protrusion 3/4, it is preferred that the male connector be located within the dimples 2/5 to better protect the male pins 17. It is also preferred that the protrusions 4 be on the top side of the panels 10 to reduce accumulation of water/moisture in outdoor installations.

When more than one modular graphic display panel 10 is assembled side-by-side to produce a larger graphics display, the modular graphic display panels 10 are physically held in alignment by dimples 5 on the left side of the right panel mating with protrusions 3 on the right side of the left panel. Likewise, when more than one modular graphic display panel 10 is assembled atop each other, the modular graphic display panels 10 are physically held together by dimples 2 on the bottom of the upper panel mating with protrusions 4 on the top of the bottom panel. In this way, several panels 10 can be joined together to form displays of many different sizes and configurations. Although the panels are capable of self-supporting, locking keys 30/40/50 (see FIGS. 4, 5 and 6) lock the panels to each other.

The front of the display modules 10 have an array of display elements 9 in one or more display tiles 8 configured to present an alpha-numeric or graphics display. In some embodiments, each display element 9 consists of a single light source, preferably a light emitting diode (LED). Although any color light source is possible, red is preferred because it is more visible to the human eye. In other embodiments, each display element 9 consists of multiple light sources of differing colors, again preferably light emitting diodes (LEDs). In this way, by varying the brightness of each LED within each individual display element 9, different colors can be obtained. In this embodiment, it is preferred that each display element 9 consist of either three LEDs, one red, one green and one blue or four LEDs, one red, one green, one blue and one white. Such configurations are known to produce realistic color graphics displays.

In a preferred embodiment, the display tiles 8 are held in place on the graphics display module 10 by screws 6. In some embodiments, the screws 6 are captivated screws, as known in the industry. Captivated screws are preferred to reduce loss of screws during maintenance. Although shown with eight screws 6, in other embodiments, different numbers of screws 6 are used. In some embodiments, one side of the tiles 8 is held in place by a hook mechanism (not shown) and the other side by screws 6. By providing a screw-access through the tiles 8, the modular graphics display module 10 is serviceable from the front, which is important when the modular graphics display module(s) 10 have an obstruction behind them such as a wall. It is anticipated that, in a lesser preferred embodiment, the tiles 8 are fastened or molded along with the enclosure walls of the modular graphics display module 10.

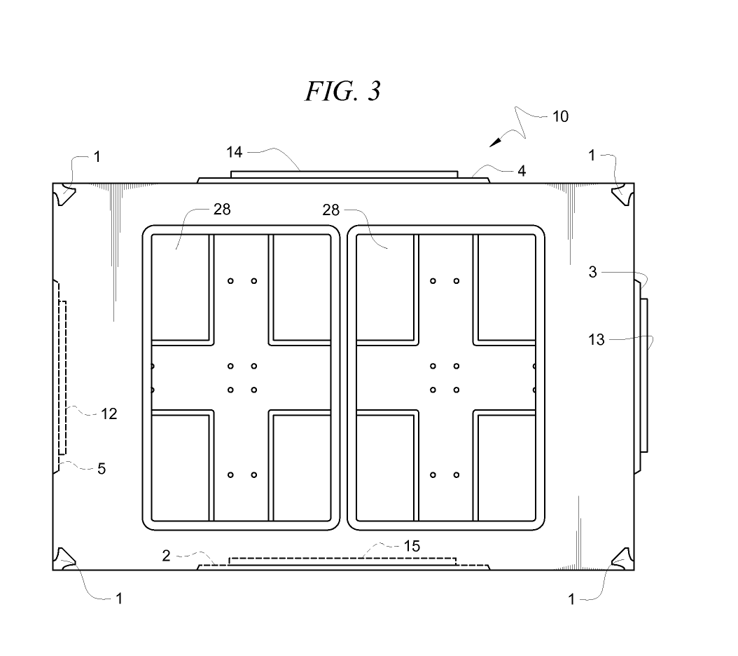

The back of the graphics display panel is shown in FIG. 3 with service openings 28 providing service access from the rear. The service openings 28 provide convenient access to the internal electronics in situations when it is not convenient to access the front service screws. There are many instances when rear service is preferred including installations where the assembled display is elevated and sufficient space is provided behind the display for service access. It is preferred to have service access covers (not shown) covering each service opening 28. The service access covers are removably fastened to the service openings 28 in any way known in the industry including hinges, screws, clips and locks. It is preferred to provide a water resistant seal between the service access covers and the service openings. The corner key holes 1 will be described in conjunction with FIGS. 4, 5 and 6.

In FIG. 4, a single-lobe locking key of the present invention is shown. The single-lobe locking key 30 is optionally inserted into the corner key holes 1 and is used to secure the modular graphics display panels 10 to a mounting surface or frame. In the preferred embodiment, the single-lobe locking key 30 has a threaded hole 32 for accepting a screw when used to fasten to a frame or other securing structure (not shown).

FIG. 5 illustrates a dual-lobe locking key of the present invention. The dual-lobe locking key 40 is optionally inserted into the corner key holes 1 where multiple modular graphics display panels 10 are deployed and two corner key holes 1 meet. The dual-lobe locking keys 40 holds two modular graphics display panels 10 together and, if needed, fasten to a mounting surface or frame. In the preferred embodiment, the dual-lobe locking key 40 has a threaded hole 42 for accepting a screw when used to fasten to a frame or other securing structure (not shown).

Referring to FIG. 6, a quad-lobe locking key of the present invention is shown. The quad-lobe locking key 50 is optionally inserted into the corner key holes 1 where multiple modular graphics display panels 10 are deployed and four corner key holes 1 meet. The quad-lobe locking keys 50 holds four modular graphics display panels 10 together and, if needed, fasten to a mounting surface or frame. In the preferred embodiment the quad-lobe locking key 50 has a threaded hole 52 for accepting a screw when used to fasten to a frame or other securing structure (not shown).

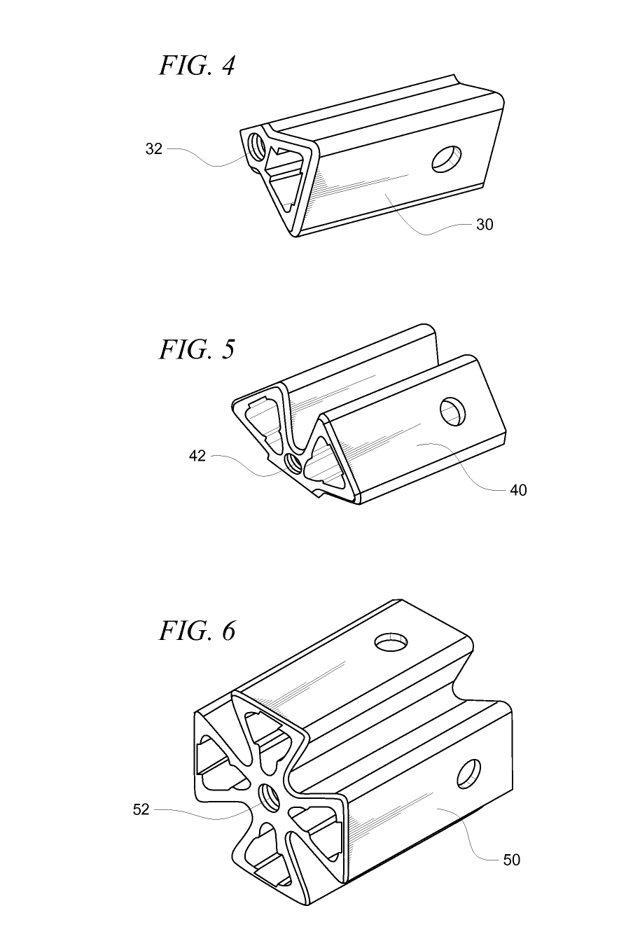

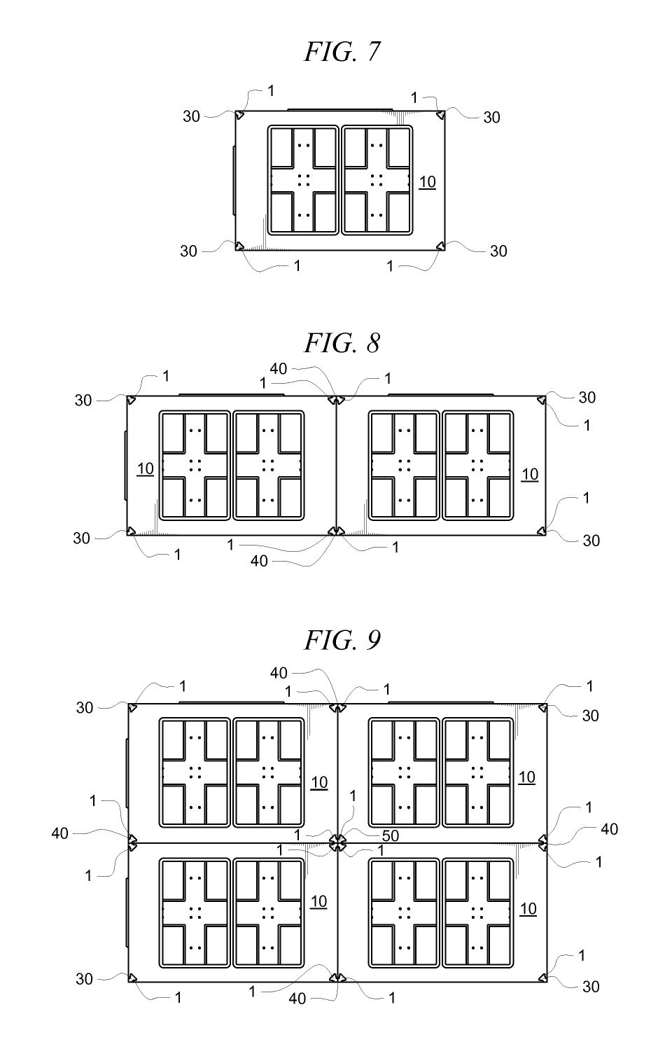

In FIG. 7, a schematic back view of a modular graphic display panel 10 of the present invention is shown with one single-lobe locking key 30 in each of the four corner key holes 1. Although not required for a single panel system, the single-lobe locking keys 30 are used in some installations to physically attach the modular graphics display module 10 to a mounting surface or frame (not shown).

In FIG. 8, a schematic back view of two modular graphic display panels 10 of the present invention are shown with two dual-lobe locking keys 40 in each of the central interfacing corner key holes 1. Although not required for a two-panel system, four single-lobe locking keys 30 are shown installed in the outer corners as some installations use the single-lobe locking keys 30 to physically attach the modular graphics display module 10 to a mounting surface or frame (not shown).

In FIG. 9, a schematic back view of four modular graphic display panels 10 of the present invention are shown with one quad-lobe locking key 50 in each of the central interfacing corner key holes 1. Although not required, four dual-lobe locking keys 40 further lock together each pair of graphic display panels for additional strength. In addition, in some installations, four single-lobe locking keys 30 are inserted into the four outer edge corner key holes and are used to physically attach the modular graphics display module 10 to a mounting surface or frame (not shown).

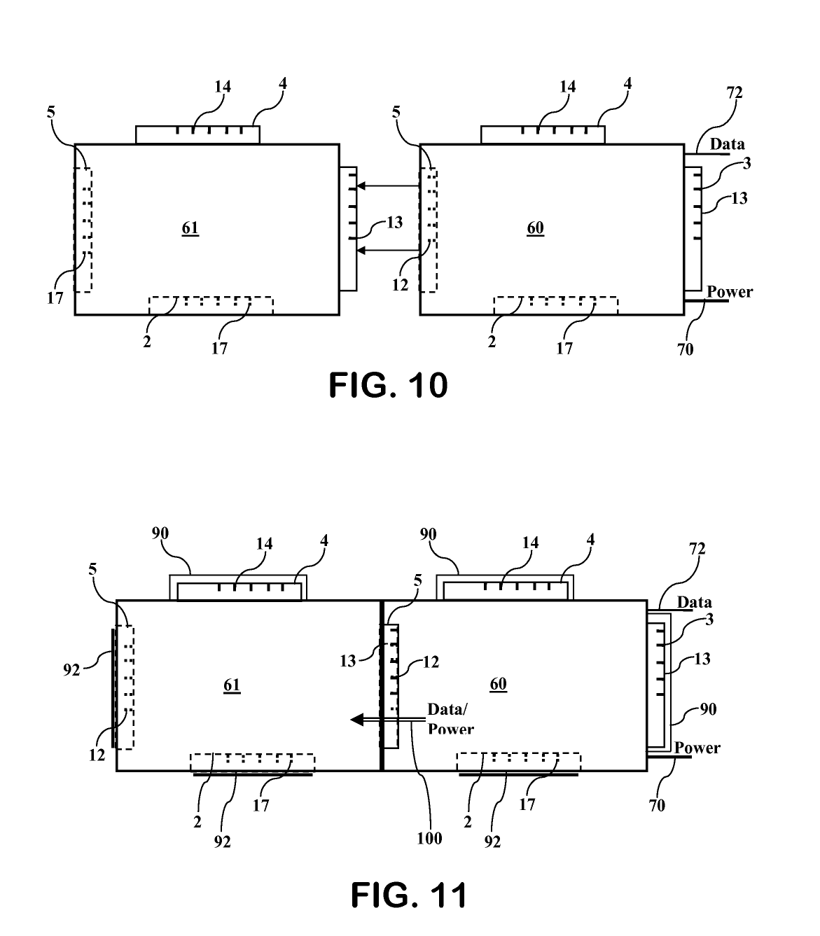

Referring now to FIGS. 10, 11 and 12, the power and data distribution of the present invention is described. In FIG. 10, two modular graphics display module 60/61 are ready to be interfaced together to form one sign. Only the right display panel 60 is connected to power 70 and data 72. In FIG. 11, the two modular graphics display module 60/61 are shown interfaced together to form one sign. The right modular graphics display module 60 is connected to power 70 and data 72 and the left modular graphics display module 61 receives power and data 100 through the connectors 12/13. In some embodiments, protective covers 90 are secured over the protrusions 3/4 to protect connectors 13/14 that are not in use. In some embodiments, protective plugs 92 are inserted into dimples 2/5 to protect connectors 12/15 that are not in use.

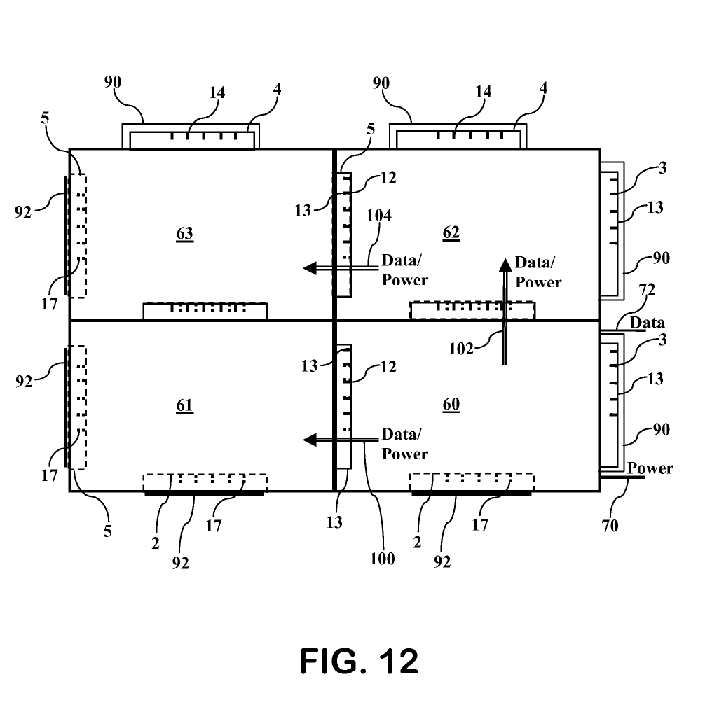

In FIG. 12, four modular graphics display modules 60/61/62/63 are interfaced together to form one sign. The bottom right modular graphics display module 60 is connected to power 70 and data 72. The top right modular graphics display module 62 receives power and data 102 from the right bottom modular graphics display module 60 through the connectors 14/15. The left bottom modular graphics display module 61 receives power and data 100 from the right bottom modular graphics display module 60 through the connectors 12/13. The left top modular graphics display module 63 receives power and data 104 from the right top modular graphics display module 62 through the connectors 12/13. Again, in some embodiments, a protective covers 90 are secured over connectors 12/13/14/15 that are not in use and in some embodiments, protective plugs 92 are inserted into dimples 2/5 to protect connectors 12/15 that are not in use.

The same method is used to connect as many modular graphics display modules 10 as needed to form signs of various sizes and resolutions. The resulting signs, with or without locking keys, function perfectly well without a frame, for example, at a basketball game resting on the floor or on a table. Alternately, in some embodiments, the resulting signs are fastened to a frame using screws passing through the frame or frame brackets and into one or more of the locking keys.

Equivalent elements can be substituted for the ones set forth above such that they perform in substantially the same manner in substantially the same way for achieving substantially the same result. It should be noted that the described system of male/female connectors and protrusions/dimples is the preferred embodiment, but other embodiments include different configurations of such. It is preferred to manufacture each modular graphics display module 10 with two pairs of protrusions/female connectors and two pairs of dimples/male connectors to reduce inventory costs, but it is anticipated that modular graphics display modules 10 designated to be non-centrally installed can be manufactured without one or two of the protrusions/dimples and/or connectors. For example, the top left modular graphics display module 63 of FIG. 12 works fine without the top protrusion 4, top connector 14 and without the left dimple 5 and left connector 12.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A modular graphics display panel comprising:
an enclosure having at least a front side and a back side, the front side having a front opening and the back side having a back opening;
an array of display elements mounted on one or more display tiles, the one or more display tiles removably affixed to the front opening of the enclosure such that components of the modular graphics display panel are serviceable from the front side of the enclosure; and
an access door removably affixed to the back opening of the enclosure such that components of the modular graphics display panel are serviceable from the rear side of the enclosure.

2. The modular graphics display panel of claim 1, whereas the display tiles are removably affixed to the front opening of the enclosure with screws.

3. The modular graphics display panel of claim 2, wherein the screws are captivated screws.

4. The modular graphics display panel of claim 1, whereas the display tiles are removably affixed to the front opening of the enclosure with at least one hook and at least one screw.

5. The modular graphics display panel of claim 4, wherein the at least one screw is a captivated screw.

6. The modular graphics display panel of claim 1, further comprising:
protrusions on two sides of the enclosure with a power/data connector mounted on the protrusions;
mating dimples on two opposite sides of the enclosure with mating power/data connectors mounted within the mating dimples; and
corner keyholes formed in each of the back corners of the enclosure for accepting locking keys.

7. The modular graphics display panel of claim 6, wherein the locking keys have one lobe for securing the modular display panels to a mounting surface.

8. The modular graphics display panel of claim 6, wherein the locking keys have two lobes for holding two of the adjacent modular graphics display panels together.

9. The modular graphics display panel of claim 6, wherein the locking keys have four lobes for holding four of the adjacent modular graphics display panels together.

10. A method of servicing a modular display panel comprising:
providing a modular display panel comprising:
an enclosure having at least a front side and a back side, the front side having a front opening and the back side having a back opening;
an array of display elements mounted on one or more display tiles, the one or more display tiles removably affixed to the front opening of the enclosure such that components of the modular graphics display panel are serviceable from the front side of the enclosure; and
an access door removably affixed to the back opening of the enclosure, such that components of the modular graphics display panel are serviceable from the rear side of the enclosure;
if the back side of the modular display panel is obstructed, servicing the modular display panel by removing at least one of the one or more display tiles; and
if the front side of the modular display panel is inaccessible, servicing the modular display panel by removing the access door.

11. The method of servicing a modular display panel of claim 10, whereas the display tiles are removably affixed to the front opening of the enclosure with screws.

12. The method of servicing a modular display panel of claim 11, wherein the screws are captivated screws.

13. The method of servicing a modular display panel of claim 10, whereas the display tiles are removably affixed to the front opening of the enclosure with at least one hook and at least one screw.

14. The method of servicing a modular display panel of claim 13, wherein the at least one screw is a captivated screw.

15. The method of servicing a modular display panel of claim 10, further comprising:
protrusions on two sides of the enclosure with a power/data connector mounted on the protrusions;
mating dimples on two opposite sides of the enclosure with mating power/data connectors mounted within the mating dimples; and
corner keyholes formed in each of the back corners of the enclosure for accepting locking keys.

16. A modular graphics display sign comprising:
at least a first modular graphics display panel and a second modular graphics display panel, each modular graphics display panel comprising:
an enclosure having at least a front side and a back side, the front side having a front opening and the back side having a back opening;
a means for displaying a graphics image, the means for displaying removably mounted on the front opening of the enclosure such that components of the modular graphics display panel are serviceable from the front side of the enclosure; and
a means for accessing the components through the back opening of the enclosure such that the components of the modular graphics display panel are serviceable from the rear side of the enclosure.

17. The modular graphics display sign of claim 16, whereas the means for displaying a graphics image is removably affixed to the front opening of the enclosure with screws.

18. The modular graphics display sign of claim 17, wherein the screws are captivated screws.

19. The modular graphics display sign of claim 16, whereas the means for displaying a graphics image is removably affixed to the front opening of the enclosure with at least means for hooking and at least one screw.

20. The modular graphics display panel of claim 19, wherein the at least one screw is a captivated screw.
